(19) United States
(12) Patent Application Publication
(10) Pub. No.: US 2006/0061018 A1
(43) Pub. Date: Mar. 23, 2006

(54) Method and device for producing straight ceramic fibres

(76) Inventors: Niemez Frank-Guenter, Rudolstadt (DE); Dieter Vorbach, Rudolstadt (DE)

Correspondence Address: CONNOLLY BOVE LODGE & HUTZ LLP, SUITE 800, 1990 M STREET NW, WASHINGTON, DC, 20036-3425, US

(21) Appl. No.: 10/489,243

(22) PCT Filed: Sep. 16, 2002
(86) PCT No.: PCT/DE02/03419

§ 371 Date: Mar. 11, 2004

(30) Foreign Application Priority Data
Sep. 15, 2001 (DE) 101 45 640.9

(51) Int. Cl. B28B 1/00

(52) U.S. Cl. 264/639

(57) ABSTRACT

The invention relates to an installation and method for producing straight ceramic fibres. Said installation essentially comprises a mixing device for producing a suspension of ceramic powder, aqueous amine oxide and cellulose. The suspension production occurs batch-wise or continuously and can take place in one or several steps with the addition of all or individual components. Said installation also comprises a device for concentrating the produced suspension of ceramic powder, aqueous amine oxide and cellulose, whereby said device intensively mixes with heating, shears and transports the suspension with water evaporation, until a precisely determined amount of water evaporates and a suspension of ceramic powder is formed in a mouldable solution of the cellulose in aqueous amine oxide. Said concentrating device also comprises a device linked to the above mentioned device, whereby the mouldable ceramic cellulose solution suspension is processed into ceramic raw fibres in a rope shape. Said concentrating device permits straight ceramic raw fibres to be formed and can be integrated with an installation, in which the raw fibre bundles are pyrolyzed and sintered.

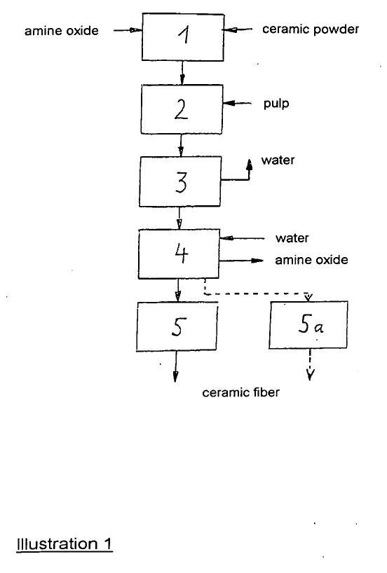

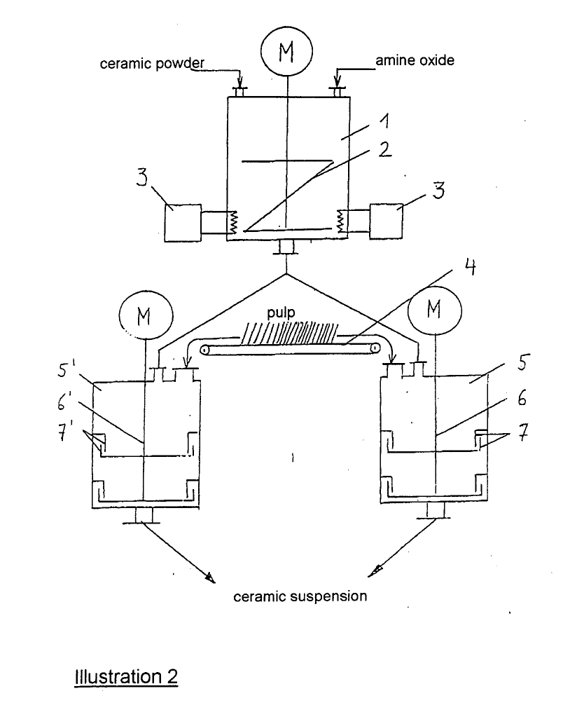

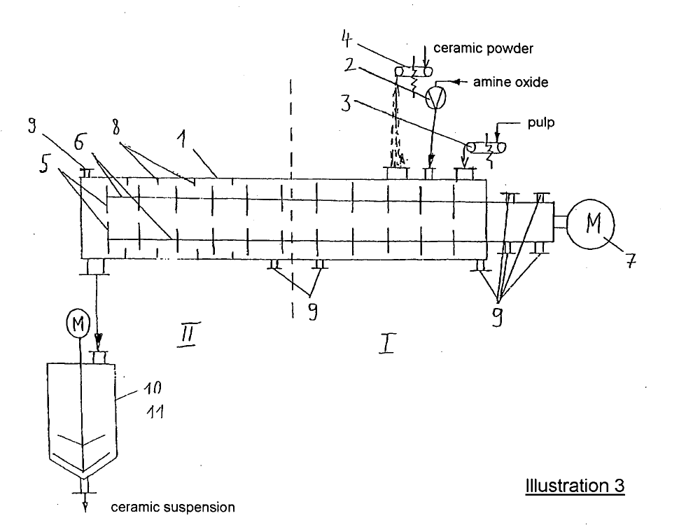

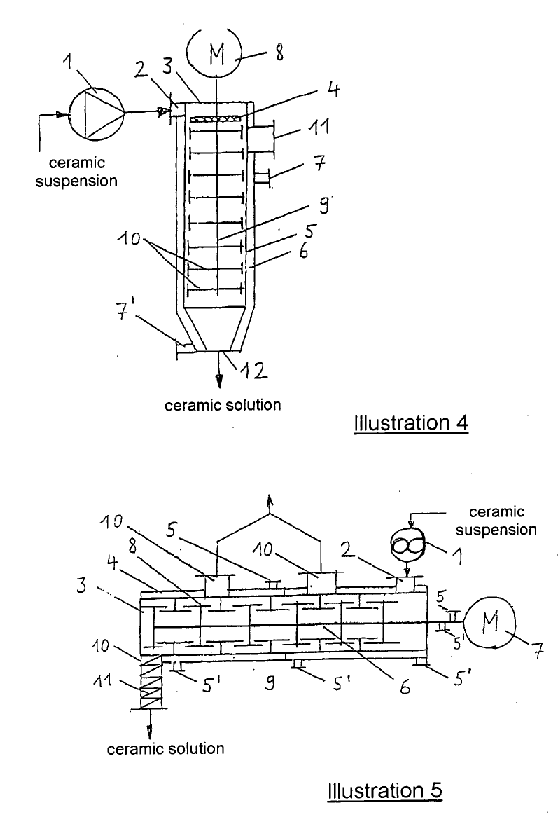

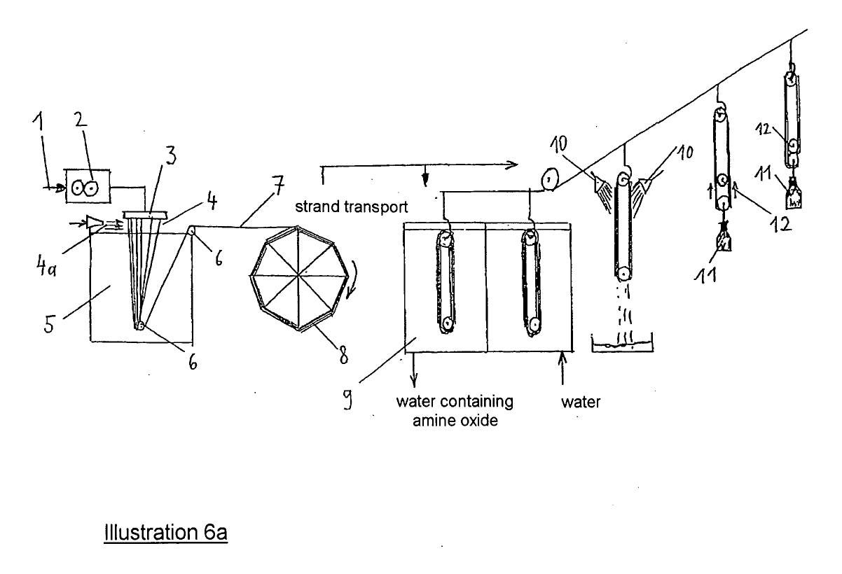

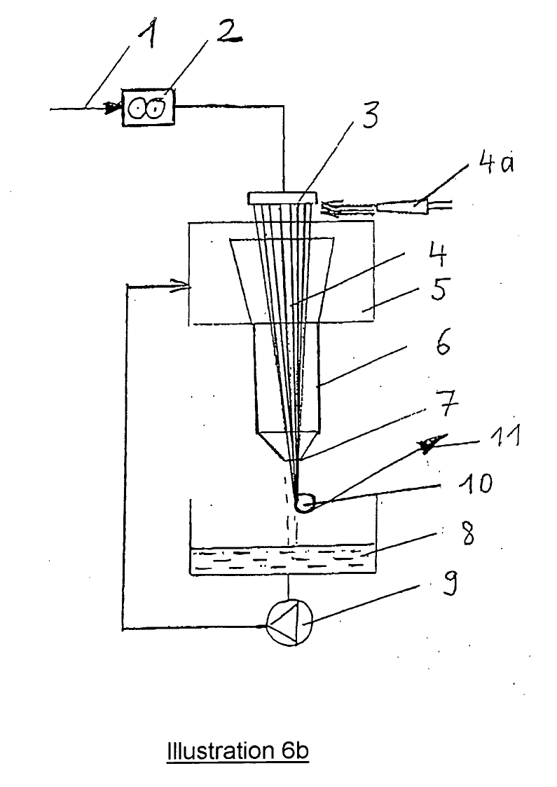

The present invention relates to a process and devices for continuous production of straight ceramic fibers in directly consecutive production stages. In effect, green fibers are generated by a solution-suspension spinning process. The ceramic fiber is preferably produced within a device immediately after the production of the green fiber.

### BACKGROUND

U.S. Pat. No. 2,179,181 discloses the ability of tertiary amine oxides to dissolve cellulose. This patent further mentions the possibility of obtaining a shaped cellulosic article, such as fibers, films and filaments for example, from the resulting cellulose-amine oxide solution by coagulation. In what follows, the term “amine oxide process” is used for simplicity to describe the operation explained above. There are no added materials in the solution, especially no ceramic powder, apart from the cellulose.

DE 4426966 mentions the possibility of producing ceramic green fiber with the aid of the amine oxide process. What is known in this connection is the production of ceramic green fibers from solutions of cellulose in amine oxide which contain a multiple of fine ceramic powders compared with the cellulose. The production of straight ceramic fibers is not discussed. Typically, ceramic green fibers are wound onto packages and thereafter, in a delayed step, pyrolyzed and sintered. The disadvantage of this process is a permanent curvature which the wound package imparts to the threads and which to some extent survives even after the sintering operation and can as a result have an adverse effect on the further processing steps of the ceramic fiber. There are many processing and application scenarios, especially in relation to the production of piezoelectric fibers, where the achievement of an exact parallel arrangement of straight fibers is an absolute prerequisite.

### OBJECT OF INVENTION

The present invention has for its object to develop a process and a device for continuous production of straight ceramic fibers in directly consecutive production stages.

For this purpose there is understood an apparatus (device) for producing ceramic fibers which according to the invention comprises essentially:
a) a mixing device for producing a suspension of ceramic powder, aqueous amine oxide and cellulose in a batchwise or continuous manner and in one or more steps by addition of all or individual constituents;
b) a device for concentrating the mixing device produced suspension of ceramic powder, aqueous amine oxide and cellulose, in which device the suspension while undergoing heating is intensively mixed, sheared and transported with evaporative removal of water until a precisely defined amount of water has evaporated off and a suspension of ceramic powder in a formable solution of the cellulose in the aqueous amine oxide has formed;
c) a device which is connected to the device described under b) and in which the formable ceramic-cellulose solution suspension is pressed through a shaping tool to form continuous filament fibers, wound up to form strands and washed off.
d) a drying device in which the strands obtained in process step c) are dried under a pre-tension and with defined overall shrinkage to form straight green fibers.
e) a pyrolysis and sintering means in which the dried green fiber strands are processed under their own weight or under a defined tension to form straight ceramic fibers.

The invention also relates to a process according to this inventive apparatus for continuous production of straight ceramic fibers.

Illustration 1 reveals the interplay of the apparatuses. The continuous execution of the sequence can be interrupted during or after stage d) and be continued at a modified time or place. Specifically, the operation concerns green fiber sintering and further processing thereof. The ceramic powder to be used is homogeneously mixed with the aqueous amine oxide in a mixing apparatus (1) which can include an ultrasonic treatment as well as mechanical stirring and shearing elements. Thereafter, the suspension obtained is mixed with pulp in a second mixing means (2). These operations can take place batchwise in two or more parallel assemblies. The preferred process embodiment envisages a continuous production of the ceramic powder-cellulose-aqueous amine oxide suspension (hereinafter referred to as “ceramic suspension”). If the assemblies are appropriately chosen, the operating stages which take place in (1) and (2) can be carried out in one assembly. The ceramic suspension obtained is exposed to a vacuum while being sheared and heated in assembly (3), a defined portion of the water in the slurry being evaporated. The result is a ceramic powder-cellulose solution suspension (hereinafter referred to as ceramic solution) which has fiber-forming character. This operation can take place batchwise in two or more parallel assemblies, but the preferred implementation of the process is the continuous production of the ceramic solution. The ceramic solution obtained, then, is spun into fibers in one apparatus (4). The ceramic solution is pressed through a shaping tool (spinneret die) through an air gap or directly into a precipitant liquid, which uses wash water to free the fibers formed from adherent amine oxide. Resulting dilute excess amine oxide can be purified and concentrated in an apparatus not shown here and be added again in apparatus (1). Before or after this wash, the continuous filament fibers obtained are wound up to form strands of defined running length. The strands can be held during the wash under a mechanical pulling tension which is applied by their own weight or by additional pulling forces. This can be realized both through weights or spring forces. Apparatus (4) has the strands being dried in accordance with process step d) under a defined pulling tension and controlledly limited shrinkage.

The apparatus (4) can preferably be configured such that it either manufactures straight ceramic green fibers which are subsequently sintered in a delayed and situationally different apparatus (5a) to form ceramic fibers or that the strands, as is preferred, are immediately thereafter pyrolyzed and sintered in accordance with process step e) in an apparatus (5).

Section a) can be configured such that the production operation for the ceramic suspension is carried out discontinuously in batch operation (illustration 2). In this case, a presuspension is produced from the aqueous amine oxide solution and ceramic powder in a mixer (1) with the aid of a stirrer (2) and ultrasound generators (3). After the presuspension has been ready produced, it is introduced into a mixing vessel chosen from mixing vessels (5) and (5′). A predetermined amount of pulp is likewise introduced, with the aid of a feed belt (4), into the mixing vessels (5) and (5′) respectively, where the predetermined amount of pulp is processed by intensive mixing with the aid of the stirrers (6)/(6′) and chicanes (7)/(7′) to form a ceramic suspension. The ceramic suspension then obtained is then further processed in these mixing vessels by heating and application of a vacuum and the resulting water removal to form a ceramic solution (not depicted in the illustration).

The operation described in section a), however, can also be carried out continuously (illustration 3). The assembly used for this purpose can be an assembly having two or more shafts. An example of the embodiment is a two-shaft assembly of the CRP series from List (CH). The shaft assembly (1) is subdivided into two sectors. Sector I is for the continuous addition of amine oxide, ceramic powder and pulp. Metering is throughput and volume controlled via a regulated pump (2) for the aqueous amine oxide and via weighing units (3) and (4) for the pulp and the ceramic powder respectively.

The shaft assembly is such that the arrangement of the shaft elements (5) on the shafts (6) driven by the motor (7) and optionally installed chicanes (8) on the housing ensure not only a transportation, a comminution of pulp sheets but also a homogeneous mixing of the three components in sector II. The assembly can optionally be temperature controlled by the shaft and/or the housing, stubs (9). The resulting suspension can be interveningly stored for further processing via an intermediate vessel (10) equipped with a stirrer (11).

Section b) is where the ceramic suspension is converted into a ceramic solution, likewise continuously or in a batch operation.

Illustration 4 shows an apparatus for converting the ceramic suspension into a ceramic solution in the form of a commercially available thin film evaporator, for example a Filmtruder from Buss (CH). The ceramic suspension passes via a metering pump (1) through the stub (2) into the thin film evaporator (3). The distributor ring (4) distributes the suspension such that it is applied in a uniform film to the stationary inner wall (5) of the thin filmer. The inner wall (5) is equipped with a heating jacket (6) having inlet and outlet lines for a heating medium (7), (7′), via which jacket the assembly is temperature controlled. A plurality of temperature zones can be formed (not depicted). The assembly further possesses a drive (8) for the shaft (9) on which there are situated a plurality of rotor blades (10). The attitude and design of the rotor blades can be chosen such that their attitude can be set parallel to or at an angle to the shaft. The rotor blades ensure by virtue of their radial distance, which is constant or variable along the assembly length, from the inner wall that a shearing and mixing stress is exerted on the suspension or solution when the rotor blades rotate. This fact and the process vacuum applied at stub (11) induce the transformation of the ceramic suspension to the ceramic solution in addition to the fact that water is evaporated at a uniform rate across the radius. The ceramic solution leaves the assembly at exit (12).

Illustration 5 shows an apparatus for converting the ceramic suspension into ceramic solution in the form of a commercially available single-shaft thick film evaporator, for example of the Discotherm series from List (CH), but it is also possible to use assemblies having two or more shafts (for example CRP from List (CH)). Illustration 5 shows a single-shaft assembly for simplicity. The ceramic suspension passes via a metering pump (1) through the stub (2) into the shaft assembly (3). The assembly is equipped via a jacket (4) with an inlet and outlet line for heating medium (5), (5′), via which the assembly is temperature controlled. A plurality of temperature zones can be formed. Similar temperature control is realizable via the shaft (6). The shaft (6) is driven by the motor (7) and fitted with compact hook elements (8). Counter-hooks (9) are installed on the wall of the assembly between the moving hook elements (8) to intensify the operation. Interplay of the hook/counter-hook shearing gap, energy input through the rotation and shearing and also heating medium and applied vacuum at the stub (10) makes it possible to convert the ceramic suspension into a fiber-forming ceramic solution. The solution exits at stub (10) with the aid of conveying means (11).

The ceramic solution obtained is according to the invention spun in section c) by various spinning processes to form ceramic fibers. Various suitable spinning systems will now be described with reference to illustrations.

The spinning process utilized can be embodied as a wet- or dry-jet wet-spinning process of the kind which are known for the production of small lyocell fibers and filaments. Not only a trough spinning process (illustration 6a) but also a funnel spinning process (illustration 6b) can be utilized. These spinning processes generally provide fibers which are homogeneous with regard to cross section. A further advantage with these processes is that profiled fibers (hollow fibers, multilayered fibers) are producible through die engineering.

In the trough spinning process (illustration 6a) the ceramic solution passes through a jacketed pipe (1), which is temperature controlled with a heat transfer medium, to the metering pump (2) which forces the suspension through a spinneret die (3). The spinneret die can be used round or rectangular, equipped with uniformly distributed or clustered (thimbles for example) drill-holes. Upon exit from the drill-hole, the extrudate is spun either through an air gap (4), where it can optionally be subjected to the flow of a quenching air stream (4a), or directly into the precipitant bath (5). In the precipitant bath, the ceramic solution coagulates to form stable continuous filament threads. The individual threads can be converged together by the deflecting roller (6) as a tow (7), and the fibers formed can be freed from adherent amine oxide using wash water. Resulting dilute excess amine oxide can be purified and concentrated in an apparatus not depicted here and be added again in section a). Before or after this wash, the continuous filament fibers obtained are wound up to form strands (8) of defined running length. The strands can be, as shown in illustration 6a, held during the wash under a mechanical pulling tension which are applied by their own weight or by additional pulling forces. This can be realized both through weights or spring forces. The washoff of the amine oxide adhering to strands is effected either by dipping in wash water (9) and/or spraying with wash water (10). The strands are further, in accordance with process step d), dried under a defined pulling tension (11) and with controlledly limited shrinkage, which is ensured by the holding device (12) for example.

In the funnel spinning process (illustration 6b) the ceramic solution passes through a jacketed pipe (1), which is temperature controlled with a heat transfer medium, to the metering pump (2), which forces the suspension through a spinneret die (3). The spinneret die is preferably round or rectangular and equipped with uniformly distributed or clustered (thimbles for example) drill-holes. After exit from the drill-holes the extrudate is spun either through an air gap, where it can optionally be subjected to the flow of a quenching air stream (4a), into a precipitant bath (5) or directly into the precipitant bath (5). The precipitant bath (5) is engineered such that a conically tapered funnel (6) with an injector (7) is installed in the bath in such a way that the extruded continuous filament threads (4) leave the injector at the downstream end of the funnel, accelerated in the direction of transport, together with the precipitant bath liquid injected by the circulating pump (9) from a catch trough (8). The fiber tow (11), bundled by the deflection (10), is then further treated in strands as described in illustration 6a (not depicted in illustration 6b).

The dry ceramic green fiber strands produced according to the various spinning processes can then be directly pyrolyzed and sintered in a downstream firing oven and are thereafter if desired cut and packaged.

The inventors have determined that the ceramic solution can have a cellulose content between 0.5-12% (mass) for stable spinning and generation of fibers having adequate properties. The content is preferably between 1.5 and 8%. The operation is suitably carried out with dissolving grade pulps suitable for viscose fiber manufacture, cotton linters and also paper grade pulps having a low or medium DP (up to 2 000). It is immaterial in this connection which production process was used to produce the pulps. The ceramic fraction in the solution should be between 50 and 5 000% based on cellulose, the preferred range being 100-3000%. The diameters of the ceramic fibers obtained are between 10 and 2 000 μm, depending on the engineering of the operation. All powders which are substantially inert toward the system of aqueous amine oxide/cellulose and which are selected from oxides (preferably metal oxides, for example aluminum oxides, silicon oxides, titanium oxides, strontium oxides etc.), carbides, borides, nitrides, oxynitrides, sialons and aluminum silicates are suitable for processing according to the processes described. It is further possible to use all ceramic-forming low or high molecular weight compounds, sinterable inorganic compounds, lead zirconium titanates. It has been determined that the operation works best with tertiary amine oxides, preferably with N-methylmorpholine N-oxide, as a solvent for the cellulose. Substances which inhibit thermal decomposition can be added to stabilize the suspension. For instance, a stabilizer system composed of aqueous sodium hydroxide solution or of sodium hydroxide solution and propyl gallate with or without further stabilizing substances can be utilized. The green fiber shrinkage allowed in the course of drying is between 0.5 and 20%, but preferably between 5 and 15%.

### LIST OF REFERENCE NUMERALS

Illustration 1:

1 Mixing apparatus 1
2 Mixing apparatus 2
3 Assembly 3 (vacuum)/water evaporation
4 Apparatus for fiber spinning
5a Sintering apparatus
5 Pyrolyzing and sintering apparatus
   Illustration 2:
1 Mixer
2 Stirrer
3 Ultrasound generators
4 Feed belt
5 and 5′ Mixing vessels
6 and 6′ Stirrers
7 and 7′ Chicanes
   Illustration 3:
1 Shaft assembly
2 Metering pump
3 Weighting unit for pulp
4 Weighing unit for ceramic powder
5 Shaft elements
6 Shaft
7 Drive motor
8 Chicanes
9 Connecting stubs
10 Intermediate vessel
11 Stirring system
   Illustration 4:
1 Metering pump
2 Stub for ceramic suspension
3 Thin film evaporator
4 Distributor ring
5 Inner wall
6 Heating jacket
7 Heating medium inlet
7′ Heating medium outlet
8 Drive
9 Shaft
10 Rotor blades
11 Stub for vacuum
12 Exit
   Illustration 5:
1 Metering pump
2 Stub (ceramic suspension)
3 Shaft assembly
4 Jacket
5 Heating medium inlet
5′ Heating medium outlet
6 Shaft
7 Drive motor
8 Hook elements
9 Counter-hooks
10 Stub (vacuum)
11 Conveying means
   Illustration 6a
1 Jacketed pipe
2 Metering pump
3 Spinneret die
4 Air gap
4a Air stream
5 Precipitant bath
6 Deflecting roller
7 Tow (converged individual threads)
8 Fiber strands
9 and 10 Wash water
11 Pulling tension
12 Holding device for shrinkage control
   Illustration 6b
1 Jacketed pipe
2 Metering pump
3 Spinneret die
4 Extruded continuous filament threads
4a Air stream
5 Precipitant bath
6 Funnel
7 Injector
8 Catch trough
9 Circulating pump
10 Deflection
11 Fiber tow

1. A process for producing straight ceramic fibers, comprising:
a) mixing ceramic powder, aqueous amine oxide and cellulose to form a suspension;
b) concentrating the suspension from a), which while undergoing heating is mixed, sheared and transported while undergoing evaporative removal of water until a suspension of the ceramic powder in a formable solution of cellulose in aqueous amine oxide has formed;
c) pressing the suspension obtained as per b) through a shaping tool to form continuous filament fibers, winding up the continuous filament fibers to form strands and washing off the strands;
d) drying the strands obtained as per c) under a pre-tension and with defined overall shrinkage to form straight green fibers;
e) processing the dried green fibers under their own weight or under a defined tension by pyrolyzing and sintering to form straight ceramic fibers.

2. A process according to claim 1, wherein a) utilizes a ceramic powder composed of oxides, carbides, borides, nitrides, oxynitrides, sialons and/or of aluminum silicates or their mixtures and/or of ceramic-forming low or high molecular weight compounds and/or sinterable inorganic compounds and/or lead zirconium titanates.

3. A process according to claim 1, wherein a) utilizes the cellulose in the form of dissolving or paper grade pulp or cotton linters.

4. A process according to claim 1, wherein the amine oxide used is N-methylmorpholine N-oxide.

5. A process according to claim 1, wherein the fraction of cellulose in the suspension generated in b) is 0.5% to 12% by weight based on the weight of the aqueous amine oxide.

6. A process according to claim 1, wherein the fraction of ceramic powder in b) is 10% to 5000% by weight based on the weight of the cellulose.

7. A process according to claim 1, wherein a) utilizes an ultrasound treatment as well as mixing.

8. A process according to claim 1, wherein c) produces the fibers by a wet-spinning process, a dry-jet wet-spinning process, a trough spinning process or a funnel spinning process.

9. A process according to claim 1, wherein the extrusion technique is chosen so that round and/or profiled and/or multilayered and/or hollow fibers are obtained.

10. A process according to claim 1, wherein the endless filament fibers emerging from the shaping tool are wound up to form strands of defined running length.

11. A process according to claim 1, characterized wherein the amine oxide in the fibers is washed off immediately after extrusion and optionally the continuous filament fibers are wound up to form strands of defined running length.

12. A process according to claim 1, wherein the strands are washed off under their own weight or under a pulling tension due to weights or spring forces.

13. A process according to claim 1, wherein the fiber strands are dried under tension to a defined shrinkage between 0.5 and 20%.

14. A process according to claim 1, wherein the green fiber strands obtained are immediately after drying strand pyrolyzed and sintered.

15. A process according claim 1, the green fiber strands after drying are cut to defined fiber lengths and thereafter bundle pyrolyzed and sintered.

16. A process according to claims 1, wherein the fibers are dried continuously under tension to a defined shrinkage between 0.5 and 20%.

17. A process according to claim 1, wherein the dried green fibers are cut into pieces and subsequently pyrolyzed and sintered.

18. A process according to claim 1, wherein the fiber diameter is adjusted result in to values between 10 and 2000 μm after the sintering operation.

19. A process according to claims 1, wherein the ceramic powder is chosen such that the ceramic fibers have piezoelectric properties.

20. Straight ceramic fibers obtainable according to a process of claim 1.

21. A device for producing straight ceramic fibers, comprising:
a) a mixing device for producing a suspension of ceramic powder, aqueous amine oxide and cellulose;
b) a device for concentrating, in which the suspension produced in a) while undergoing heating is intensively mixed, sheared and transported while undergoing evaporative removal of water until a precisely defined amount of water has evaporated off and a suspension of ceramic powder in a formable solution of cellulose in aqueous amine oxide has formed,
c) a device which is downstream to that mentioned under b) or can be connected to it and wherein the suspension of ceramic powder in a formable solution of the cellulose in aqueous amine oxide is pressed through a shaping tool to form continuous filament fibers, wound up to form strands and washed off,
d) a drying device in which the strands obtained in c) are dried under a pre-tension and with defined overall shrinkage to form straight green fibers, and
e) a pyrolysis and sintering means in which the dried green fibers are processed under their own weight or under a defined tension to form straight ceramic fibers.

22. A device according to claim 21, wherein the mixing device is a continuous assembly having two or more shafts and a mixing, transporting and shearing action.

23. A device according to claim 21, wherein the mixing device and/or the device for concentrating comprises at least one stirred vessel in batch operation.

24. A device according to claim 21, wherein the device for concentrating comprises a thin film evaporator.

25. A device according to claim 21, charaterized in that the device for concentrating comprises a thick film evaporator.

26. A process according to claim 2, wherein the amine oxide used is N-methylmorpholine N-oxide.

27. A process according to claim 3, wherein the amine oxide used is N-methylmorpholine N-oxide.
